(19) United States
(12) Patent Application Publication
(10) Pub. No.: US 2012/0124468 A1
(43) Pub. Date: May 17, 2012

(54) Electronic Apparatus Having a Touch-Controlled Interface and Method of Displaying Figures Related to Files within a certain Time Period

(75) Inventor: Chih-Woei Tsai, Tainan City (TW)

(73) Assignee: ALTEK CORPORATION, Hsinchu (TW)

(21) Appl. No.: 13/019,474

(22) Filed: Feb. 2, 2011

(30) Foreign Application Priority Data
Nov. 16, 2010 (TW) 099139352

(51) Int. Cl. G06F 3/048

(52) U.S. Cl. 715/702

(57) ABSTRACT

An electronic apparatus having a touch-controlled interface includes a display unit, a touch-controlled unit, and a display interface. The touch-controlled unit is provided on the display unit, while the display interface is arranged on the display unit for showing figures related to files. When the touch-controlled unit is touched, a signal is generated to make the display interface respond. Further, the display interface shows a time scroll bar, and a user may touch different points of the time scroll bar to define a time period, and thus the display interface is made to show the figures of target files accessed in the time period. Furthermore, a display method includes steps of displaying the figures of files via the display interface, touching the time scroll bar on the display interface to define the time period, and displaying the figures of target files accessed in the time period via the display interface.

### FIELD OF THE INVENTION

This invention relates to an electronic apparatus and particularly to the electronic apparatus provided with a touch-controlled interface on which multiple touch points and a time scroll bar are featured for more efficient management of large number of files.

### BACKGROUND OF THE INVENTION

In view of popular digital still cameras and digital video cameras, users can increasingly generate electronic multimedia files (still picture files, video files, and audio files) by themselves. However, it is quite difficult for the users to keep all of the files, so that the users probably save the files not managed. Further, a file browse interface is currently classified into a touch-controlled scroll paging interface, an all-file view interface, and a point-based browse interface, but an interface of management based on time information for browsing is very rare. In order to solve the problems and defects described above, an improved touch-controlled interface formed with a time scroll bar is provided.

Consequently, because of the technical defects of described above, the applicant keeps on carving unflaggingly through wholehearted experience and research to develop the present invention, which can effectively improve the defects described above.

### SUMMARY OF THE INVENTION

To solve the mentioned-above defects of prior art, an electronic apparatus having a touch-controlled interface according to this invention is provided, being characterized with a multiple-point touch control and a time scroll bar.

For an objective of this invention, the electronic apparatus having the touch-controlled interface comprises a display unit, a touch-controlled unit, a display interface, and a processing unit. The touch-controlled unit is arranged on the display unit, the touch-controlled unit may generate a touch control signal when being externally touched, and the processing unit is electrically connected to the display unit and the touch-controlled unit respectively. The display interface is arranged on the display unit for users to view figures related to saved files. When the user touches the touch-controlled unit, a signal is generated and the display interface is thus made to respond. Further, the display interface is formed with a time scroll bar, and the user may touch different points of the time scroll bar to define a time period, and thus the display interface is made to show the figures of target files accessed in the time period. The target file is merely image data. Actually, the size of figure related to the target file on the display interface automatically varies with the amount of displayed files. In other words, the size of figure related to the target files is inversely proportional to the amount of files. It is nevertheless especially noted that, in this invention, the processing unit is used to process the figure related to the target file accessed in the time period and then show it on the interface.

Generally, different locations may be not only touched along the time scroll bar to form different points, but also the locations may be directly touched and moved along the time scroll bar to dynamically form different points. Thus, when the user touches to drag the time scroll bar, the time scroll bar is defined to have a time-based unit, or when the user touches to drag an adjacent region over the time scroll bar to define to have another time-based unit. Further, in this invention, the time-based unit varying with each pixel unit touched for drag along the time scroll bar may be adjusted; the adjustment may be made up and down along the time scroll bar and by means of surrounding touch and moving.

A method of displaying figures within a certain time period according to this invention is provided, comprising the following steps.

Step 1: Displaying a plurality of figures of saved files via the display interface of display unit.

Step 2: Touching a first point and a second point along the time scroll bar on the display interface to define the time period.

Step 3: Displaying a plurality of figures related to the saved target files accessed in the time period via the display interface.

Generally, the electronic apparatus having the touch-controlled interface and method of displaying figures related to files within a certain time period according to this invention has one or more advantages, as follows:
(1) With the electronic apparatus having the touch-controlled interface and method of displaying figures related to files within a certain time period, the user may touch different points on the time scroll bar so as to make the display interface instantly show the figures of target files accessed at 2 different points.
(2) With the electronic apparatus having the touch-controlled interface and method of displaying figures related to files within a certain time period, if there are excessive files to be shown, the size of figure of the target file will be correspondingly reduced.

### BRIEF DESCRIPTION OF THE DRAWINGS

FIG. 1A is a schematic view illustrating an electronic apparatus having a touch-controlled interface according to this invention.

FIG. 1B is a block diagram of the electronic apparatus having the touch-controlled interface according to this invention.

FIG. 2 is a schematic view illustrating the electronic apparatus having the touch-controlled interface in a first embodiment of this invention.

FIG. 3A is a schematic view illustrating the electronic apparatus having the touch-controlled interface in a second embodiment of this invention.

FIG. 3B is a schematic view illustrating the electronic apparatus having the touch-controlled interface in a third embodiment of this invention.

FIG. 4 is a schematic view illustrating the electronic apparatus having the touch-controlled interface in a fourth embodiment of this invention.

FIG. 5 is a flow chart of a method of displaying figures related to files in a certain time period according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

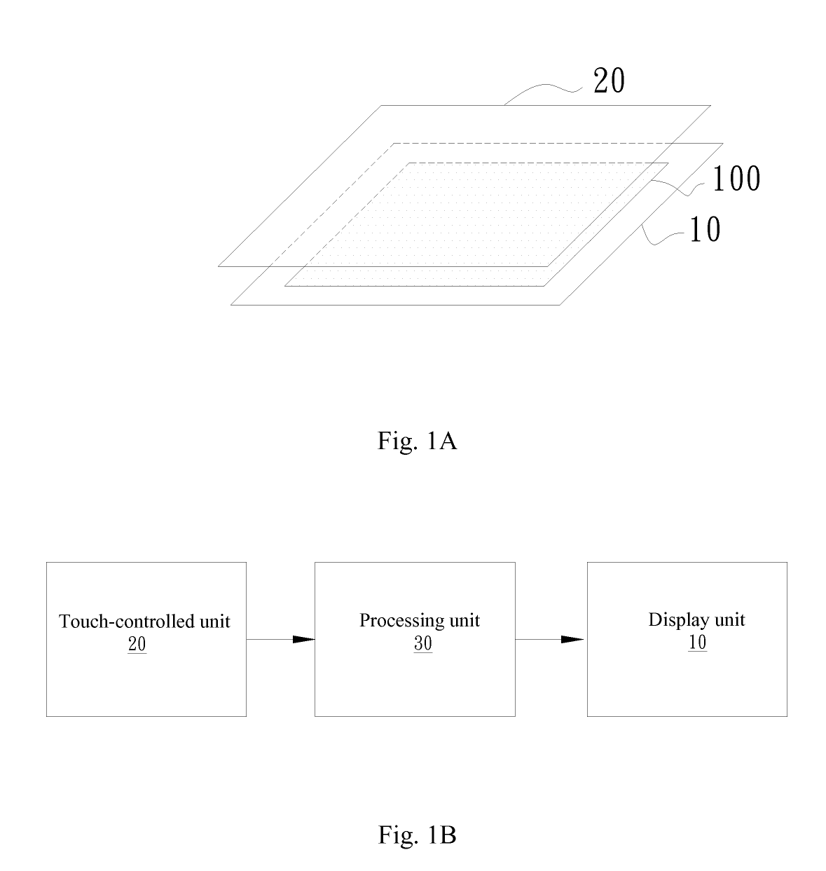

Refer to FIG. 1A and FIG. 1B shown respectively as a schematic view and a block diagram of an electronic apparatus having a touch-controlled interface according to this invention. As shown in FIG. 1A and FIG. 1B, the electronic apparatus having the touch-controlled interface according to this invention comprises a display unit 10, a touch-controlled unit 20, and a display interface 30. The touch-controlled unit 20 is arranged on the display unit 10, the touch-controlled unit 20 may generate a touch control signal when being externally touched, and the processing unit 30 is electrically connected to the display unit 10 and the touch-controlled unit 20 respectively. The display interface 100 is arranged on the display unit 10 to allow users to view figures related to the saved files. When a user touches the touch-controlled unit 20, a signal is generated and the display interface 100 is thus made to respond. The display interface 100 is a touch panel well known in a common market and may be applied to a terminal display, a digital still camera, or a laptop PC in all forms.

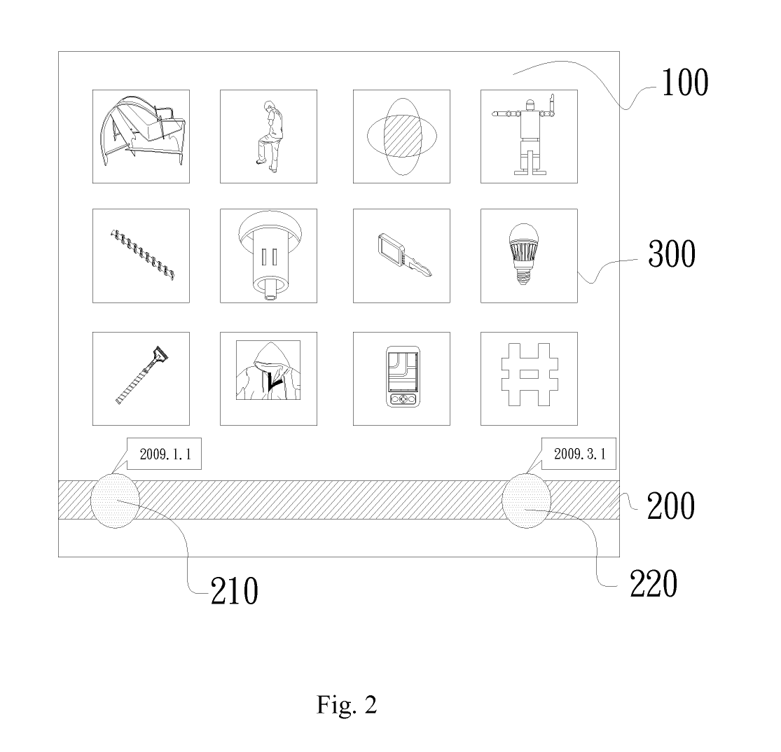

Further, refer to FIG. 2 which shows a schematic view illustrating the electronic apparatus having the touch-controlled interface in a first embodiment of this invention. As shown in FIG. 2, the display interface 100 of electronic apparatus having the touch-controlled interface is formed with a time scroll bar 200, and thus a user may touch different points of the time scroll bar 200 to define a time period, and the display interface 100 is made to show figures 300 related to a plurality of saved target files accessed in the time period. Detailedly specking, the user touches two random points that are separately defined to a first point 210 and a second point 220 along the time scroll bar 200 on the display interface 100. With reference to FIG. 2, the time corresponding to the first point 210 is Jan. 1, 2009 (abbreviated as 2009.1.1 and, briefly described in this invention, the following sets are shown by analogy), while the time corresponding to the second point 220 is Mar. 1, 2009. Accordingly, after the first point 210 and second point 220 along the time scroll bar 200 are defined, the display interface 100 correspondingly shows the figures 300 related to the target files accessed between the first point 210 and the second point 220, immediately. Concretely, the display interface 100 shows 12 pictures shot in 2 months, ranging from 2009.1.1 to 2009. 3.1. It is remarkable that, in the first embodiment, the target file is merely image data, which is an only example without limit to this invention. It is nevertheless especially noted that, in this invention, the processing unit 30 is used to process the figures 300 related to the target files accessed between the first point 210 and the second point 220 in the time period, and then the figures are shown on the display interface 100.

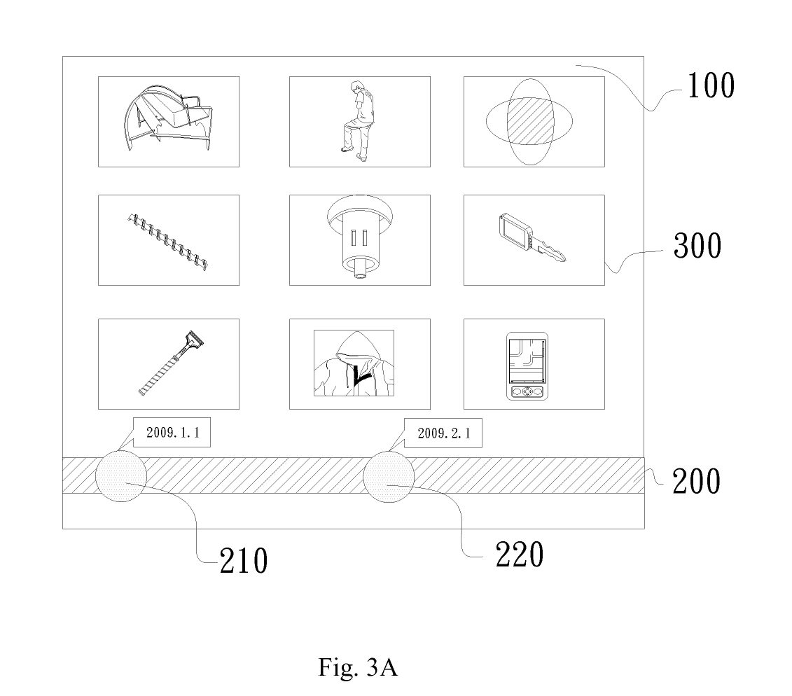

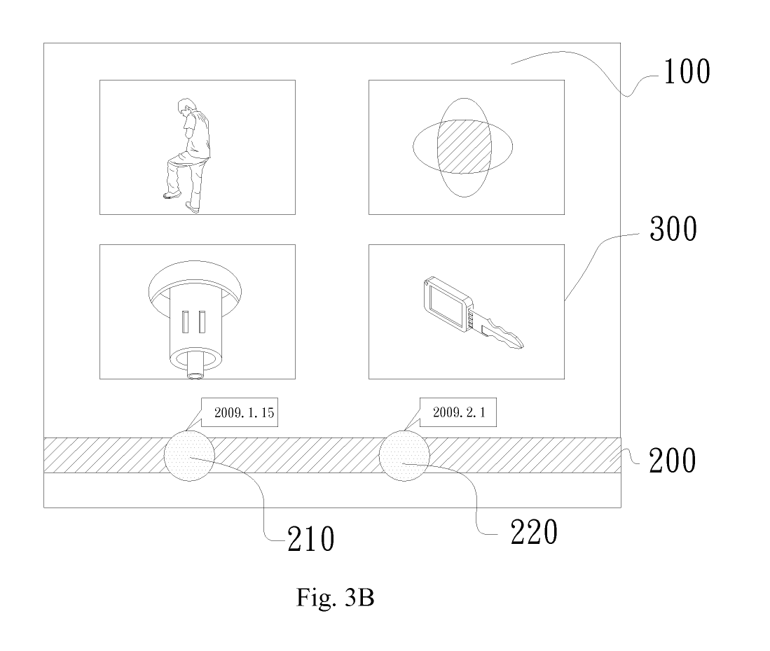

Next, refer to FIG. 3A and FIG. 3B shown respectively as a schematic view illustrating the electronic apparatus having the touch-controlled interface in a second embodiment of this invention, and a schematic view illustrating the electronic apparatus having the touch-controlled interface in a third embodiment of this invention. As shown in FIG. 3A, the first point 210 along the time scroll bar 200 still stays at 2009.1.1, but the second point 220 is changed 2009.2.1 (previously staying at 2009.3.1 in the first embodiment). In other words, the time period described in the second embodiment is changed from 2 months in the first embodiment to 1 month. Besides, 12 pictures are changed to 9 pictures that will be shown, and each picture zooms in. Generally specking, the size of figure. 300 related to the target file on the display interface 100 automatically varies with the amount of figures 300 related to the displayed target files. In principle, the size of figure 300 related to the target files is inversely proportional to the amount of files. Namely when there are more target files shown on the display interface 100, the figures 300 related to the target files is smaller; contrarily, there are fewer target files shown on the display interface 100, the figures 300 related to the target files is larger.

Alternatively, in a third embodiment shown in FIG. 3B, the first point 210 along the time scroll bar 200 is changed to 2009.1.15 (but 2009.1.1 for the first point in the second embodiment), and the second point 220 is kept to stay at 2009. 2.1. Likewise, in the third embodiment, the time period is changed from 1 month described in the second embodiment to half month. Further, 9 pictures are changed to 4 pictures that will be shown, and each picture zooms in again. Thus, from the description made above, apparently, it is characterized in this invention that the user may touch different points along the time scroll bar 200 to show the figures 300 related to the target files accessed between the different time periods. When the time period is longer, there are more figures 300 related to the target files and the figures 300 are smaller; contrarily, when the time period is shorter, there are fewer figures 300 related to the target files and the figures 300 are larger. For this reason, the time scroll bar 200 according to this invention may be adjusted for different requests of easy use and availability.

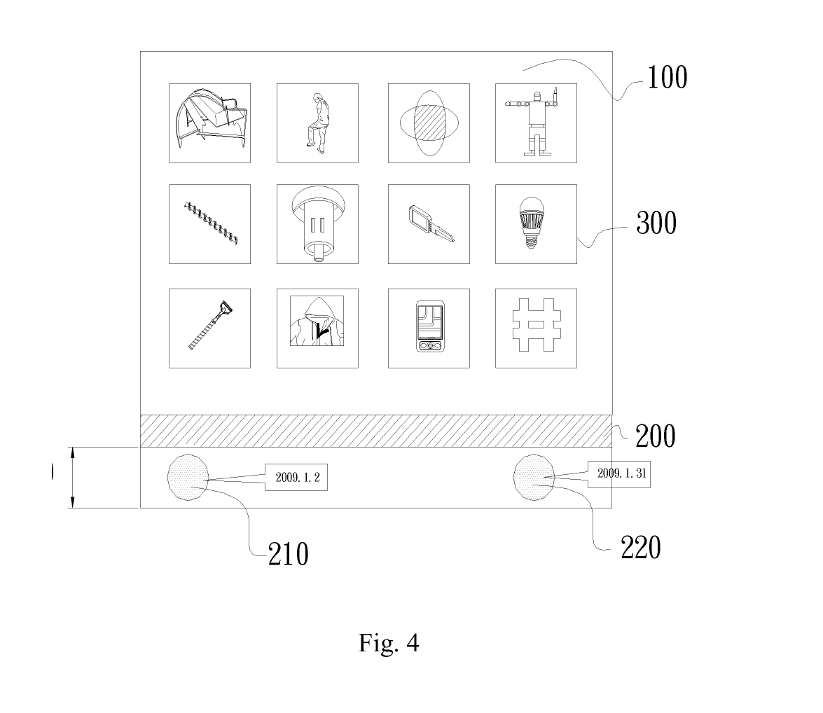

Further, refer to FIG. 4 shown as a schematic view illustrating the electronic apparatus having the touch-controlled interface in a fourth embodiment of this invention. Being apparent from the description made above, in this invention, different locations may be not only touched along the time scroll bar 200 to form the first point 210 and the second point 220, but also the locations may be directly touched and moved along the time scroll bar 200 to dynamically form the first point 210 and the second point 220. In a word, when the user touches and drags the time scroll bar 200, the time period formed with the first point 210 and the second point 220 is also dynamically changed and the figures 300 related to the target files that are shown on the display interface 100 thus vary continuously. However, it is doubted that the time-based unit that is correspondingly changed is constant when the time scroll bar 200 is dragged each time. Basically, when the time scroll bar 200 is touched and dragged, one pixel unit formed once the time scroll bar 200 is moved is corresponding to one time-based unit formed when the time scroll bar 200 is changed. Namely, in the first embodiment through the third embodiment, 10 pixels that are moved along the time scroll bar 200 correspondingly cause one week of time variation. In the fourth embodiment, 10 pixels are moved under the time scroll bar, which causes one day of time variation. Basically, when the user touches and drags the time scroll bar 200, one pixel unit formed once the time scroll bar 200 is moved is corresponding to one time-based unit formed when the time scroll bar 200 is changed. If an adjacent region 110 below the time scroll bar 200 is touched and dragged, a second time-based unit of the time scroll bar 200 is correspondingly changed. The second point 220 shown in FIG. 4 is changed from 2009. 3.1 described in the first embodiment to 2009. 1.31. When the user touches and drags the time scroll bar 200, the time scroll bar 200 is defined to have a time-based unit; when the user touches and drags an adjacent region 110, the time scroll bar 200 is defined to have another time-based unit. However, the time variation corresponding to the pixel that is dragged along the time scroll bar 200 or is dragged over the region below the time scroll bar 200 is differently defined in case of different use, which is a merely example. In other words, the time-based unit varying with each pixel unit touched and dragged along the time scroll bar 200 may be adjusted. In the fourth embodiment, when the user touches and drags the region below the time scroll bar 200, the time-based unit varying with each pixel unit that is moved is adjusted (from one week to one day). However, the change made over the region below the time scroll bar 200 is not limited, and an equivalent change made over a surrounding region above or below the time scroll bar 200 is a claim of this invention.

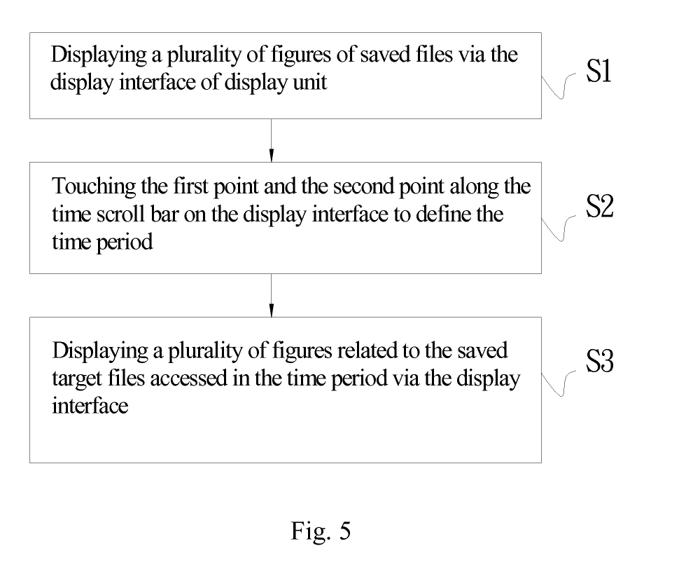

Next, refer to FIG. 5 shown as a flow chart illustrating a method of displaying figures related to files within a certain time period according to this invention. As shown in FIG. 5, the method of displaying the figures within a certain time period according to this invention comprises the following steps.

Step S1: Displaying a plurality of figures of saved files via the display interface of display unit.

Step S2: Touching the first point and the second point along the time scroll bar on the display interface to define the time period.

Step S3: Displaying a plurality of figures related to the saved target files accessed in the time period via the display interface.

The target file is image data and the size of figure related to the target file varies with the amount of figures related to the target files shown on the display interface. Between the step of defining the time period and the step of showing the figures related to the target files, a step of touching the time scroll bar to define the time scroll bar to have a time-based unit or touching and dragging an adjacent region over the time scroll bar to define the time scroll bar to have another time-based unit is included.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic apparatus having a touch-controlled interface, comprising:
a display unit;
a touch-controlled unit, being provided on the display unit and being touched to generate a touch-control signal; and
a display interface, being arranged on the display unit for viewing a plurality of figures related to saved files and responding to the touch-control signal, wherein the display interface is formed with a time scroll bar and a user touches different points along the time scroll bar to define a time period, so as to make the display interface show the plurality of figures related to the saved target files accessed in the time period.

2. The electronic apparatus having the touch-controlled interface according to claim 1, wherein the target files are image data.

3. The electronic apparatus having the touch-controlled interface according to claim 1, wherein the amount of the target files shown on the display interface is inversely proportional to the size of figure of each of the target files.

4. The electronic apparatus having the touch-controlled interface according to claim 1, wherein the user touches and drags the time scroll bar to define the time scroll bar to have a time-based unit and the user touches and drags an adjacent region over the time scroll bar to define the time scroll bar to have another time-based unit.

5. The electronic apparatus having the touch-controlled interface according to claim 1, further comprising a processing unit that is electrically connected to the display unit and the touch-controlled unit respectively, wherein the processing unit is used to process the figures related to the target files accessed in the time period for showing the figures on the interface.

6. A method of displaying figures related to files within a certain time period, comprising:
displaying a plurality of figures of saved files via a display interface of a display unit;
touching a first point and a second point along a time scroll bar on the display interface to define a time period; and
displaying a plurality of figures related to the saved target files accessed in the time period via the display interface.

7. The method of displaying the figures related to the files within a certain time period according to claim 6, wherein between the step of defining the time period and the step of showing the figures related to the target files, a step of touching and dragging the time scroll bar to define the time scroll bar to have a time-based unit or touching and dragging an adjacent region over the time scroll bar to define the time scroll bar to have another time-based unit is further included.

8. The method of displaying the figures related to the files within a certain time period according to claim 6, wherein the amount of the target files shown on the display interface is inversely proportional to the size of figure of each of the target files.

9. The method of displaying the figures related to the files within a certain time period according to claim 6, wherein the target files are image data.
